(19) United States
(12) Patent Application Publication
(10) Pub. No.: US 2025/0341276 A1
(43) Pub. Date: Nov. 6, 2025

(54) MODULAR UTILITY BRACKET

(71) Applicant: MACLEAN POWER L.L.C., Fort Mill, SC (US)

(72) Inventors: Habeeb GHOSSEIN, Hoover, AL (US); Adrian CANDELARIA, Alabaster, AL (US)

(73) Assignee: MACLEAN POWER L.L.C., Fort Mill, SC (US)

(21) Appl. No.: 19/198,873

(22) Filed: May 5, 2025

Related U.S. Application Data
(60) Provisional application No. 63/642,098, filed on May 3, 2024.

(51) Int. Cl. F16M 13/02

(52) U.S. Cl. CPC F16M 13/02

(57) ABSTRACT

A modular utility bracket assembly for supporting utility components on a utility pole is provided. The assembly has a base plate having a rear surface configured for secure attachment to the utility pole and an opposing front surface. A central base fitting with a central receptacle is removably secured to the front surface of the base plate, along with two side base fittings, each having side receptacles configured to receive corresponding side utility arms. The side base fittings differ structurally from the central base fitting and are independently attachable via removable fasteners.

### CROSS-REFERENCE TO RELATED APPLICATIONS

This application claims the benefit of U.S. provisional application Ser. No. 63/642,098 filed May 3, 2024, the disclosure of which is hereby incorporated in its entirety by reference herein.

### TECHNICAL FIELD

This application relates to a relates to a utility bracket assembly and method for mounting the bracket assembly to a utility pole for the transmission and distribution of power.

### BACKGROUND

Three-phase brackets for utility poles are structural assemblies specifically engineered to support three electrical conductors used in a three-phase power distribution system. Typically fabricated from materials such as fiberglass for their strength, non-conductivity, and weather resistance, these brackets mount horizontally or in an arched configuration at or near the top of a utility pole. Each bracket is designed to maintain precise spatial separation between the three conductors, securing them via insulators attached at predetermined positions along the bracket arms. This spatial arrangement is critical to maintaining correct phase-to-phase and phase-to-ground clearances, thereby ensuring safe operation and minimizing the risk of electrical faults, flashovers, and outages. In addition to providing mechanical support for the weight and tension of conductors, three-phase brackets also help to manage dynamic loads from wind, ice accumulation, and mechanical vibrations, playing an essential role in maintaining the structural and electrical integrity of the overhead distribution system. Their reliable performance is crucial for preserving system balance, minimizing line losses, and ensuring uninterrupted delivery of electrical service across the network.

### SUMMARY

According to at least one embodiment, a modular utility bracket assembly for a utility pole is provided. The assembly includes a base plate having a rear surface for mounting to a utility pole and a front surface opposite the rear surface. A central base fitting is configured to be connected to the base plate and having a central receptacle. The assembly in includes two side base fittings, each side base fitting having a side receptacle. A plurality of utility arms are each configured to be inserted into the receptacle of either the central base fitting or one of the side base fittings. A plurality of fasteners removably secure the central base fitting and the secondary base fittings to the base plate.

In another embodiment, the central receptacle extends generally perpendicular to the front surface of the base plate, wherein the side receptacles extend from opposite sides of the base plate. In another embodiment, the side receptacles extend generally parallel to the front surface. In another embodiment, the side receptacles extend at an angle to the front surface.

In another embodiment, the central base fitting has a first orientation feature and the side base fittings have a second orienting feature, wherein the first and second orientation features cooperate to align the central base fitting and the side base fittings in an aligned configuration. In another embodiment, the first orientation feature comprises a notch and the second orientation feature on the side base fitting comprise a fin that engages the notch. In another embodiment, the first and second orientation features align the side receptacles being generally parallel to each to each other, and the central receptacle being perpendicular to the side receptacles.

In another embodiment, the base plate includes a first locating feature and the central base fitting and side base fittings have a second locating feature, wherein the first and second locating features cooperate to position the central base fitting and side base fittings on the base plate in a mounting configuration.

In another embodiment, the first locating feature comprises at least one fastener, and the second locating feature comprises an aperture through which the fastener extends. In another embodiment, the first at least one fastener comprises at least two threaded fasteners securing the central base fitting and side fittings to the base plate.

In another embodiment, at least one mounting slot extending through the base plate configured for attaching the base plate to a utility pole with a fastener.

In another embodiment, each of the utility arms comprises an end fitting for securing to a utility component.

According to at least one embodiment, a modular utility bracket assembly is provided having a base plate having a rear surface for mounting to a utility pole and a front surface opposite the rear surface. A first arm assembly includes a first base fitting to be secured to the front surface of the base plate. A second arm assembly includes a second base fitting to the front surface of the base plate; wherein the second base fitting is different than the first base fitting. The first base fitting and the at least one secondary base fitting are removably secured to the base plate with fasteners.

In another embodiment, the first arm assembly includes a first utility arm secured to a first receptable in the first base fitting and the first arm assembly includes a secondary utility arm secured to a second receptacle in the secondary base fitting.

In another embodiment, a third arm assembly third base fitting is configured to be secured to the front surface of the base pate and having a third receptacle for receiving a third utility arm.

In another embodiment, the base plate has a housing formed along the front surface for aligning the first and second base fittings in a mounting configuration.

In another embodiment, the housing has a plurality of side walls projecting from the front face of the base plate, wherein a peripheral edge of the first and second fitting are positioned inside the side walls of the housing.

According to at least one embodiment, a method for assembling a bracket to a utility pole is provided. A base plate is attached to a utility pole. A central arm assembly is connected to the base plate with a central base fitting. A plurality of secondary arm assemblies are connected to the base plate with secondary base fittings.

In another embodiment a plurality of utility arms is provided, each arm having a first crimp-able end and a second end. The first crimp-able end is inserted of each arm into the receptacle a receptacle formed on one of the central base fitting or the secondary base fittings. The first crimp-able end of each arm is crimped to secure receptacle to secure it within the on the central base fitting or the secondary base fitting.

In another embodiment, the method includes fastening bolting the central base fitting and the secondary base fittings to the base plate thereby securing the central arm assembly and the secondary arm assemblies to the utility poll.

### BRIEF DESCRIPTION OF THE DRAWINGS

FIG. 1 illustrates a modular utility bracket assembly mounted on a utility pole, according to one or more embodiments of the present application.

FIG. 2 illustrates a shipping and storage configuration of the modular utility bracket assembly according to one or more embodiments of the present application.

FIG. 3 illustrates a portion of the modular utility bracket in FIG. 1 shown partially assembled.

FIG. 4 illustrates the portion of the modular utility bracket in FIG. 3 being assembled.

FIG. 5 illustrates a cross-section view of the modular utility bracket in FIG. 1 along section 5-5.

FIG. 6 illustrates a modular utility bracket assembly in use according to one or more embodiments of the disclosure.

FIG. 7 illustrates a portion of the modular utility bracket in FIG. 6 shown partially assembled.

FIG. 8 illustrates the portion of the modular utility bracket in FIG. 3 being assembled.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure.

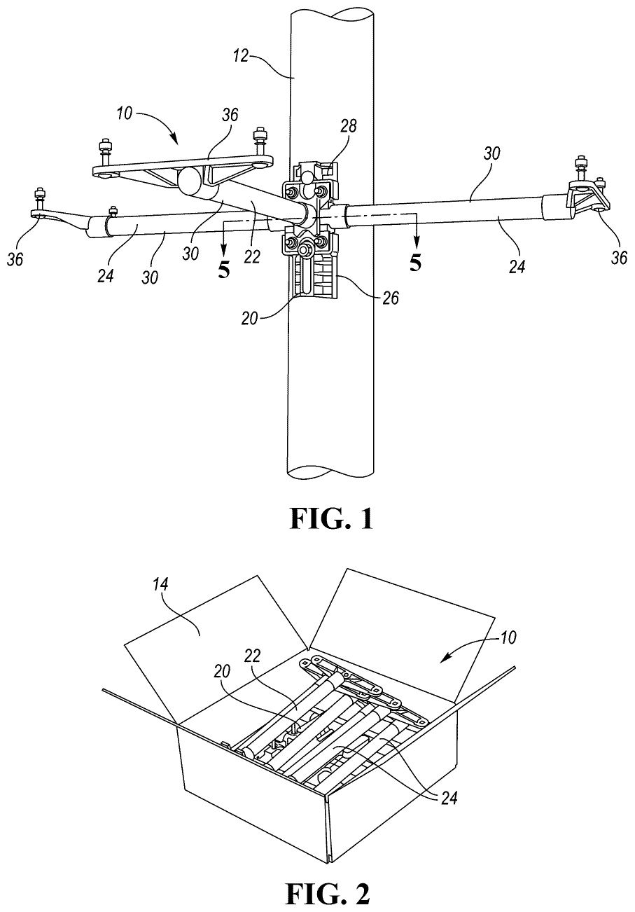

Utility poles frequently rely on brackets to support electrical and communication lines. As shown in FIG. 1, the present disclosure relates to a modular utility bracket assembly 10 for mounting to a utility pole 12 according to one embodiment. The modular utility bracket 10 has a plurality of support arms 22, 24 that are configured to support various types of equipment, such as transformers, insulators, or crossarms. The modular utility bracket 10 of the present application allows each support arm 22, 24 to be easily attached and detached to a base plate 20 in a modular system that provides numerous advantages over pre-assembled prior art assemblies.

Utility brackets are typically manufactured as fixed, single piece fitting with the arms permanently attached to the fitting using methods such as epoxy potting. However, this manufacturing method has several drawbacks, including inefficient storage and transportation due to their bulky, pre-assembled nature.

While these single-piece brackets provide strength, non-conductivity, and weather resistance, the pre-assembled or one-piece multi-phase fiberglass brackets presents significant logistical and operational challenges. Specifically, these fully assembled units occupy a substantial amount of space in storage facilities and on bucket trucks or line trucks. Their bulky nature restricts the number of units that can be stored outdoors or transported at any one time, resulting in slower response times for field crews and reduced overall system efficiency during emergency deployments such as storm recovery operations.

The single-piece bracket designs also contribute to inefficient utilization of available storage space. Units are often suspended from pallets, leading to overhang that obstructs the movement of personnel and equipment within stockyards. This not only increases the risk of damage to the brackets but also complicates stock management and retrieval processes. Furthermore, because the brackets are fully assembled at the factory, any logistical inefficiency—such as excessive stockyard congestion, restricted truck load capacities, and greater susceptibility to breakage—translates directly into increased costs and operational delays. These problems are especially pronounced during storm events, where rapid and efficient deployment of replacement parts is critical to restoring service.

Accordingly, there exists a significant need for an improved fiberglass bracket system that addresses these inefficiencies. A modular solution that reduces storage volume, enhances truck-loading capacities, minimizes breakage during handling, and facilitates quicker, more effective storm response would substantially improve utility field operations and infrastructure resilience.

The modular utility bracket assembly 10 overcomes the limitations of conventional, single-piece designs. The modular utility bracket assembly 10 provides a system of base portions that can be easily assembled in the field or at a manufacturing facility, while still meeting the required performance and durability standards of a one-piece design. The modular utility bracket assembly 10 may improve quality control, reduce storage space requirements, and allow for greater flexibility in customizing bracket configurations at a point of installation.

As shown in FIG. 2, the modular bracket assembly 10 can be shipped in a standard box 14 since the components can easily be assembled in the field. The modular bracket assembly 10 includes a base plate 20, a first arm assembly 22 and a second arm assembly 24. As illustrated in FIG. 1, the base plate 20 mounts to the utility pole 12 along a rear surface 26 and a front surface 28 oriented opposite the rear surface 26. The modular bracket assembly 10 may include the first arm assembly 22 which is a central arm assembly and may include two second arm assemblies 24 which are side arm assemblies. However, there may be alternate configurations with a central base fitting 32 and a single side base fitting 34, or only a central base fitting 32.

The arm assemblies 22, 24 may be easily fastened to the base plate 20 in the field. When disassembled, the modular assembly 10, or multiple assemblies 10, can be packed and shipped in boxes, which prevents damage to the parts instead of being shipped on unprotected pallets. This also enables greater packing density, which saves space on bucket trucks and in warehouses.

The first arm assembly 22 is provided with a first base fitting 32 configured to be removably secured to the front surface of the base plate 20 using mechanical fasteners, such as bolts or screws. A second arm assembly 24 includes a second base fitting 34 that is structurally distinct from the first base fitting. Both the first and second base fittings are designed to interface with the base plate in a modular fashion, allowing for rapid assembly and disassembly. The differing geometries of the base fittings may serve functional purposes, such as facilitating specific orientations, phased spacing, or system customization, while the use of removable fasteners enables flexible field installation and component replacement without the need for specialized tools or permanent attachment methods.

Another advantage of this design of modular utility bracket assembly 10 is the ability to mix and match various phase or arm configurations at the point of installation. The universal hole pattern on the base plate may accommodate for different size spacing holes on a utility pole. The modular design of the utility bracket 10 offers substantial benefits in terms of storage and transportation efficiency. By storing the individual arms and base plates separately, the space required for inventory may be greatly reduced, minimizing the risk of overstocking, and allowing for more efficient use of storage space at distribution facilities. Responsive to demand, an appropriate number of brackets and number of arms may be assembled with base portions onto the base plates.

Each arm assembly 22, 24 may have arms 30 made of fiberglass and can have end fittings 36 crimped to the fiberglass arm for securing to a utility component. The end fittings 36 may also be attached with adhesives or other processes such as epoxy potting. The end fittings 36 may be designed to be secured to utility components such as insulators, transformers, crossarms or conductor hardware or other utility components. As shown in FIG. 1, the end fitting 36 may be a double-car configuration but may also be a triple-car configuration to accommodate varying mounting requirements and provide enhanced stability and load distribution for different system designs. The end fittings 36 may be crimped to the fiberglass arms 30. The arms 30 can be crimped onto the central and side base fittings 32, 34. This modular design enables the creation of configurable single, double, or triple phase assemblies, depending on specific requirements of an installation site.

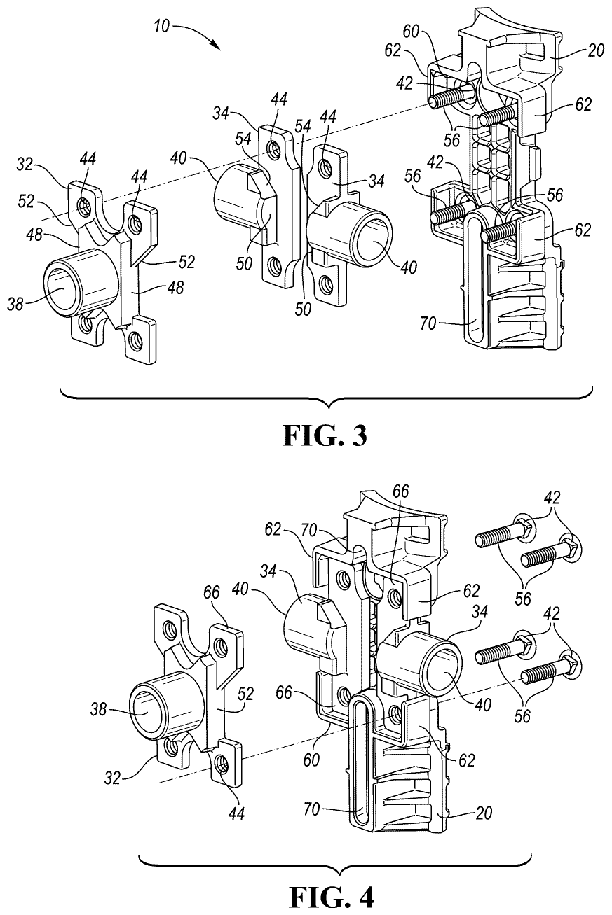

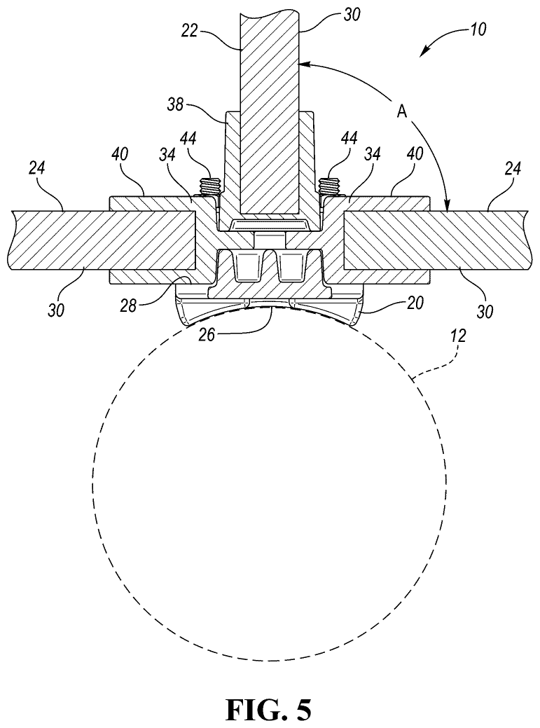

FIG. 3 and FIG. 4 illustrate the bracket hardware of the base plate 20 and first and second fittings 32, 34 with the fiberglass arms 30 removed. The central base fitting 32 is configured to be removably connected to the base plate 20. The central base fitting 32 defines a central receptacle 38 configured to securely receive and support a central utility arm. Positioned on opposite sides of this central base fitting 32 are two side base fittings 34. Each side base fitting 34 has a side receptacle 40 designed to receive and secure respective side utility arms.

In one embodiment, as shown in FIGS. 3-4, the central receptacle 38 extends generally perpendicular from the front surface 28 of the base plate 20, with the two side receptacles 40 extending outwardly from opposite sides of the base plate 20. As shown, the side receptacles may be oriented generally parallel to the front surface and oriented 180-degrees opposite each other. In yet another embodiment, the side receptacles 40 may be upswept at an angle A (FIG. 5) relative to the central receptacle 38. The upswept angle A may be less than 90-degrees. For example, the angle A may in the range of 45 degrees to 85-degrees from the central receptacle. Conversely, if the angle is measured from a plane parallel to the front surface 28 of the base plate 20, the angle may be 5-degrees to 45-degrees. In one embodiment, the angle A may be generally 75-degrees Similarly, if the angle is measured from a plane parallel to the front surface 28 of the base plate 20, the angle may be 15-degrees. The side receptacles 40 may be positioned at any suitable angle relative the central receptacle 40 or the front surface 28 of the base plate 20. These upswept angles may allow tailored installation in different applications, as well as ensuring consistent conductor spacing and facilitating effective three-phase power distribution.

The modular utility bracket assembly 10 incorporates locating features to ensure alignment and proper positioning of the central and side base fittings 32, 34 during installation. As shown in FIGS. 3-5, the base plate 20 includes a first locating feature 42 comprising at least one fastener 56, and each of the central and side base fittings 32, 34 includes a corresponding second locating feature, such as an aperture designed to align precisely with the fastener. This arrangement allows the central and side base fittings 32, 34 to be accurately aligned on the base plate 20. The assembly 10 may include at least two fasteners 56. As illustrated, the assembly may include four fasteners 56. The fasteners 56 may include a threaded bolt and nuts to securely fasten the base fittings 32, 34 to the base plate 20.

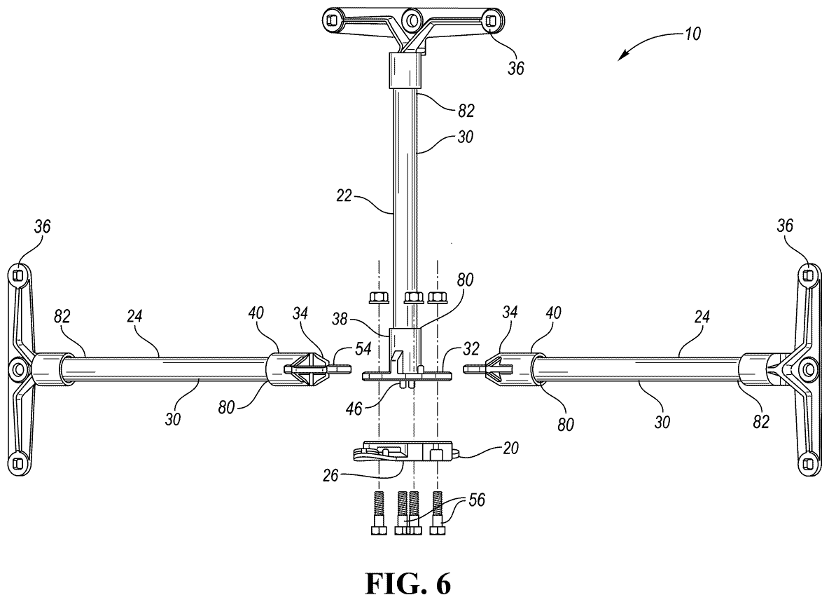

In another embodiment, as shown in FIGS. 6-8, the locating feature may be guide pins 46 on the central and side base fittings 32, 34 that engage openings on the base plate 20. As illustrated in this embodiment, the central base fitting 32 may be installed onto the base plate 20 first, followed by the installation of the two side base fittings 34. Alternatively, in the embodiment in FIGS. 3-5, the installation sequence can be reversed, allowing the two side base fittings 34 to be installed first, with the central base fitting 32 secured afterward.

The base plate 20 includes a housing 60 defined by side walls that project outward from the front face 28. The housing 60 may have a defined boundary that provides further locating and orienting features for the central and base fittings 32, 34. A portion of peripheral edges 66 of the first and second fittings 32, 34 are positioned within the confines of these projecting side walls 62 to provide additional positioning and also improves mechanical stability of the assembly 10.

The peripheral edges 66 of the fittings 32, 34 closely abut and contact the internal surfaces of the housing side walls 62. This direct contact between the base fittings 32, 34 and side walls 62 of the housing 60 provides structural support that effectively transfers mechanical loads from the arm assemblies 22, 24 to the housing 60 itself, rather than relying solely on the bolts or fasteners. By redistributing and absorbing these loads from external forces, such as wind loading or cable tension, the direct edge-to-wall contact configuration substantially reduces stress on the bolts, minimizes the risk of fastener loosening or failure, and enhances the overall durability and stability of the bracket assembly during operational stresses such as wind, ice, and conductor tension.

The modular utility bracket assembly 10 has orientation features that ensure the correct alignment and installation of the arm assemblies 22, 24, to prevent errors during and help make the assembly process go faster. Specifically, the central base fitting 32 incorporates a first orientation feature 48, such as a notch 52, while each of the side base fittings 34 includes a complementary second orientation feature 50, such as a fin or projection 54. When installing the fittings, the fin 54 engages the notch 52, providing a mechanical confirmation that the base fittings 32, 34 are aligned and oriented properly. This interlocking arrangement prevents inadvertent misalignment and guarantees the end fittings and attached utility arms face the intended direction. As shown in FIGS. 3-4, the side base fittings 34 include a fin 54 with an angled portion. The central base fitting 32 has a notch 52 with a corresponding angled surface that mates with the angled portion on the fins 54.

Further, the cooperation between these orientation features 48, 50 maintains proper positioning of the central base fitting 32 and the corresponding central arm assembly 22. By integrating these poka-yoke orientation features 48, 50, the modular bracket assembly significantly reduces installation errors, facilitates quicker assembly in the field, and enhances the structural integrity and reliability of the resulting utility support structure.

FIG. 5 is a cross-sectional view taken along line 5-5 of FIG. 1, illustrating the mounting configuration of the central and side base fittings 32, 34 relative to the base plate 20. In this view, the side base fittings 34 are shown directly abutting and engaging the front surface 28 of the base plate 20. The central base fitting 32 is stacked atop the side base fittings 34, showing the layered assembly of the base fittings 32, 34. In other embodiments, like in FIGS. 6-8, the central base fitting 32 may abut the front surface 28 of the base plate 20 and the side fittings 34 may be stacked on the central fitting 32.

The modular utility bracket assembly 10 further comprises at least one, and optionally two, mounting slots 70 extending through the base plate 20. The slots 70 facilitate attachment of the assembly 10 directly to a utility pole 12 using suitable fasteners such as bolts or lag screws. The mounting slots 70 allow for positional adjustments during installation, enabling linemen to secure the bracket assembly on the pole. The mounting slots 70 are accessible through grooves or cutouts in the base fittings 32, 34, allowing the bracket assembly 10 to be mounted onto or removed from a utility pole 12 either before or after the fittings are secured to the base plate.

FIGS. 6-8 illustrate a modular utility bracket assembly 10 according to another embodiment. FIG. 6 shows an exploded isometric view of an assembled modular utility bracket 10. The modular utility bracket 10 has a base plate 20 configured to be attached to a utility pole 12. A central base fitting 32 is configured to be connected to the base plate via guide pins 46. The central base fitting 32 has a central receptacle 38 for receiving a first arm 30.

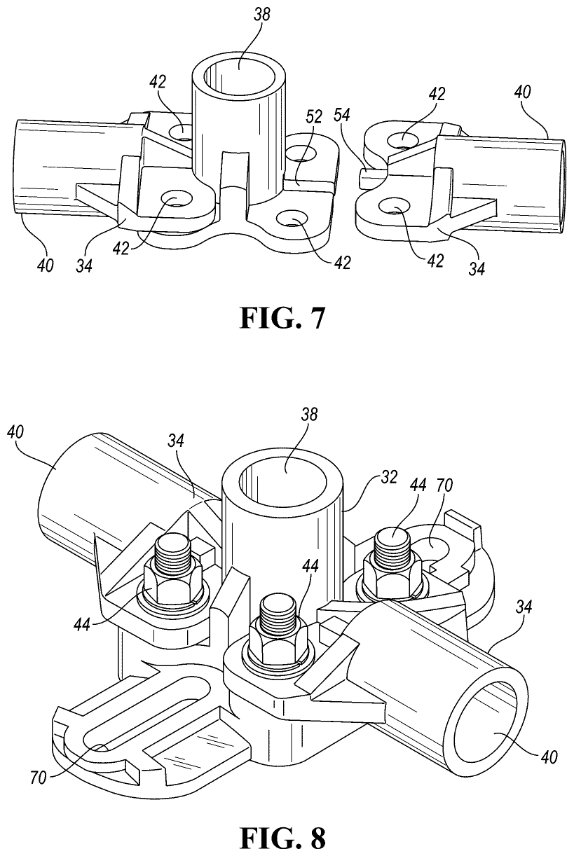

FIG. 7 shows base fittings 32, 34 of modular utility bracket 10 partially assembled. One side base fitting 34 is slidably coupled to a central base fitting 32 and a second side base fitting 34 is shown arranged to with its guiding fin 54 in line with the receiving slot of the center base fitting. The fins 54 allow them to fit together seamlessly, ensuring a stable and reliable connection point for the arms. A plurality of side base fittings 34 are slidably connectable to the central base fitting 32. Each side base fitting 34 has fins 54 for aligning the side base fitting 34 with the central base fitting 32.

FIG. 8 shows base fittings 32, 34 as fit together with the central base fitting 32. In this aligned configuration, the central base fitting 32 aligns with the base plate 20. The base fittings 32, 34 are aligned with the base plate 20 using hardware 56.

In the embodiments in FIGS. 1-5 and FIGS. 6-8, each side base fitting 34 also has a side receptacle 40 for receiving a side arm 30. The arms 30 each have a first end 80 and a second end 82. The crimp-able first end 80 is configured to be inserted into the receptacle 38 of the central base fitting 32 or the receptacle 40 of one of the side base fittings 34. A plurality of fasteners or hardware 56 may be used for removably securing the central base fitting 32 and the side base fittings 34 to the base plate 20. In the configuration shown in FIG. 6, the modular utility bracket 10 has both the central base fitting 32 and side base fittings 34. However, the modular utility bracket 10 may be assembled with just the central base fitting 32, or the modular utility bracket 10 may be assembled with central base fitting 32 and either of the side base fittings 34.

In the embodiments in FIGS. 1-5 and FIGS. 6-8, the base plate 20 may serve as the mounting point for the modular utility bracket 10 on a utility pole 12. The base plate 20 may have various hole patterns to accommodate various arm configurations. The two side base fittings 34 may be coupled to a central base fitting 32. The side base fittings 34 and central base fitting 32 are designed to securely attach arms 30 to the base plate 20, ensuring a robust connection capable of withstanding the forces exerted by the supported equipment. The fasteners or hardware 56 are used to fasten the arms 30 and base fittings 32, 34 to the base plate 20. The hardware 56 may include bolts, nuts, and washers. The hardware 56 may be made from suitable durable materials such as aluminum or steel.

The modular utility bracket assembly 10 provides a method of easy assembly to a utility pole 12. First, the base plate 20 is assembled to the utility pole 12. Next, the central and side base fittings 32, 34 are connected to the base plate 20. The central and side base fittings 32, 34 may be connected in any order, or may be configured to be connected in a specific order. In the embodiment in FIGS. 1-5, the side base fittings 34 may be connected first to the base plate 20. Then the central base fitting 32 may be connected to the base plate 20. In the embodiment in FIGS. 6-8, the central base fitting 32 may be connected first to the base plate 20, and then the side base fitting 34 may be connected to the base plate 20.

The method also involves providing arms 30 each with a crimp-able first end 80 and a second end 82. The first end of each arm 30 is inserted into the receptacles 38, 40 of either the central or secondary base fittings 32, 34. The receptacle 38, 40 is crimped to the first end 80 of the arm 30. Then the central and secondary base fittings 32, 34 are fastened to the base plate 20.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A modular utility bracket assembly for a utility pole comprising:
a base plate having a rear surface for mounting to a utility pole and a front surface opposite the rear surface;
a central base fitting configured to be connected to the base plate and having a central receptacle;
two side base fittings, each side base fitting having a side receptacle;
a plurality of utility arms each configured to be inserted into the receptacle of either the central base fitting or one of the side base fittings; and
a plurality of fasteners for removably securing the central base fitting and the secondary base fittings to the base plate.

2. The modular utility bracket assembly of claim 1, wherein the central receptacle extends generally perpendicular to the front surface of the base plate, wherein the side receptacles extend from opposite sides of the base plate.

3. The modular utility bracket assembly of claim 1, wherein the side receptacles extend generally parallel to the front surface.

4. The modular utility bracket assembly of claim 1, wherein the side receptacles extend at an angle to the front surface.

5. The modular utility bracket assembly of claim 1, wherein the central base fitting has a first orientation feature and the side base fittings have a second orienting feature, wherein the first and second orientation features cooperate to align the central base fitting and the side base fittings in an aligned configuration.

6. The modular utility bracket assembly of claim 5, wherein the first orientation feature comprises a notch and the second orientation feature on the side base fitting comprise a fin that engages the notch.

7. The modular utility bracket assembly of claim 5, wherein the first and second orientation features align the side receptacles being generally parallel to each to each other, and the central receptacle being perpendicular to the side receptacles.

8. The modular utility bracket assembly of claim 1, wherein the base plate includes a first locating feature and the central base fitting and side base fittings have a second locating feature, wherein the first and second locating features cooperate to position the central base fitting and side base fittings on the base plate in a mounting configuration.

9. The modular utility bracket assembly of claim 1, wherein the first locating feature comprises at least one fastener, and the second locating feature comprises an aperture through which the fastener extends.

10. The modular utility bracket assembly of claim 1, wherein the first at least one fastener comprises at least two threaded fasteners securing the central base fitting and side fittings to the base plate.

11. The modular utility bracket assembly of claim 1, further comprising at least one mounting slot extending through the base plate configured for attaching the base plate to a utility pole with a fastener.

12. The modular utility bracket assembly of claim 1, wherein each of the utility arms comprises an end fitting for securing to a utility component.

13. A modular utility bracket assembly comprising:
a base plate having a rear surface for mounting to a utility pole and a front surface opposite the rear surface;
a first arm assembly including a first base fitting to be secured to the front surface of the base plate;
a second arm assembly including a second base fitting to the front surface of the base plate; wherein the second base fitting is different than the first base fitting;
wherein the first base fitting and the at least one secondary base fitting are removably secured to the base plate with fasteners.

14. The modular utility bracket assembly of claim 13, further comprising:
wherein the first arm assembly includes a first utility arm secured to a first receptable in the first base fitting; and
wherein the first arm assembly includes a secondary utility arm secured to a second receptacle in the secondary base fitting.

15. The modular utility bracket assembly of claim 13, further comprising:
a third arm assembly third base fitting to be secured to the front surface of the base pate and having a third receptacle for receiving a third utility arm.

16. The modular utility bracket assembly of claim 13, wherein the base plate has a housing formed along the front surface for aligning the first and second base fittings in a mounting configuration.

17. The modular utility bracket assembly of claim 13, wherein the housing has a plurality of side walls projecting from the front face of the base plate, wherein a peripheral edge of the first and second fitting are positioned inside the side walls of the housing.

18. A method for assembling a bracket to a utility pole comprising:
attaching a base plate to a utility pole;
connecting a central arm assembly to the base plate with a central base fitting;
connecting a plurality of secondary arm assemblies to the base plate with secondary base fittings.

19. The method of claim 18, further comprising:
providing a plurality of utility arms, each arm having a first crimp-able end and a second end;
inserting the first crimp-able end of each arm into the receptacle a receptacle formed on one of the central base fitting or the secondary base fittings;
crimping the first crimp-able end of each arm to secure it within the receptacle of on the central base fitting or the secondary base fitting.

20. The method of claim 18, further comprising
fastening bolting the central base fitting and the secondary base fittings to the base plate thereby securing the central arm assembly and the secondary arm assemblies to the utility poll.
